(19) United States
(12) Patent Application Publication
(10) Pub. No.: US 2010/0180829 A1
(43) Pub. Date: Jul. 22, 2010

(54) SKIMMER FOR AQUARIUMS

(75) Inventor: Valerio BRESOLIN, Vicenza (IT)

Correspondence Address: GRIFFIN & SZIPL, PC, SUITE PH-1, 2300 NINTH STREET, SOUTH, ARLINGTON, VA, 22204, US

(73) Assignee: HYDOR SRL, Vicenza (IT)

(21) Appl. No.: 12/567,480

(22) Filed: Sep. 25, 2009

(30) Foreign Application Priority Data
Jan. 21, 2009 (IT) VE2009A000003

(51) Int. Cl. A01K 63/04

(52) U.S. Cl. 119/261; 210/167.26

(57) ABSTRACT

In a skimmer (20,100) for aquariums comprising a first container (30) able to contain water of an aquarium (80), and water-air mixing means (50) which create a mixed flow of water and air which enters into said first container (30) to generate a foam and, finally, collecting means (40) of said foam, the mixing means (50) are placed inside said first container and are also submersion means, namely they work when they are immersed in water, said first container (30) is provided with a water suction duct (67) and air supply means (66,68) connected to said mixing means (50), so that said mixing means (50) may mix water to be purified with air taken from the outside environment, thus creating a mixed flow of water and air which rising upwards generates a foam which is collected inside said collecting means (40). The first container (30) is further provided with at least one opening (34) from which purified water goes out.

The present invention relates to a skimmer used for purifying water contained in aquariums.

As already known, in aquariums, above all the sea aquariums, namely the aquariums containing sea or salt water, organic substances generated by fish, invertebrates and plants contained inside the aquarium, are formed. As time passes the organic substances decompose forming toxic substances or, in any case, harmful substances for the life in the aquarium, such as nitrates and phosphates.

In order to eliminate such harmful substances, purification devices for water are used which are called skimmers.

A skimmer essentially consists of a cylindrical container positioned outside an aquarium connected to an inlet duct in order to receive, from one side, water to be purified from the aquarium and, from the other side, an outlet duct to re-introduce purified water into the aquarium. Moreover, it is provided with an outside recirculation device for water in order to mix water with environmental air, that is there is a suction duct in order to taken water from the cylindrical container by means of a standard pump for aquariums and a delivery duct in order to re-introduce water into the cylindrical container. In the suction duct, air is sucked from outside by means of a Venturi tube which is provided with an air intake opening. In this way, a lower pressure is created inside the Venturi tube and, through the air intake opening, air is taken from the outside and introduced into the suction duct of the pump.

A mixed flow of water and air reaches the pump and enters into the impeller of the pump and comes out from the delivery duct, and then it re-enters into the cylindrical container.

A mixed flow of water and air arrives into the cylindrical container, thus air bubbles are formed and they rise upwards creating a foam which collects the harmful substances contained in the water. A collecting glass is place at the top of the cylindrical container inside which the foam, containing the harmful substances, is collected and, therefore, the glass must be regularly emptied.

However, the skimmers of the above described prior art have many drawbacks.

In fact, many ducts have to be connected to the cylindrical container: an inlet duct in order to bring aquarium water to be purified inside the cylindrical container, an outlet duct in order to bring the purified water from the cylindrical container into the aquarium, a suction duct in order to take out water from the cylindrical container and bring it into the pump along which there is a Venturi tube in order to mix water with air and, finally, a delivery duct in order to re-introduce water from the pump to the cylindrical container. Thus it is easy to understand that the structure of the skimmer is complex and bulky and its production is very difficult with subsequent cost increase.

But there are other serious drawbacks. In fact, the flow which arrives at the entry of the pump is a mixed flow of water and air, whereby the pump does not work in optimum conditions and, then, very high power is required in order to generate a mixed flow of water and air and to reintroduce this mixed flow inside the cylindrical container of the skimmer.

Furthermore, this skimmer generates air bubbles of great dimensions whereas, as it is known, for an efficient purification it is necessary that the air bubbles are of small dimensions so that they are more numerous. In such a way, a greater amount of foam is produced, thus increasing the purification action of water.

Moreover, in this kind of skimmer, the outlet duct which returns water from the cylindrical container into the aquarium is a siphon-like duct whose height has to be manually adjusted according to the water level contained inside the aquarium with respect to the cylindrical container; this is inconvenient and, in addition, it makes the product more complex.

The aim of the present invention is then to make a skimmer wherein the above-mentioned drawbacks of the prior art skimmers are eliminated.

In particular, the skimmer must be simple, of reduced dimension and of easy construction.

Moreover, the mixing means necessitate a low power for its functioning and to produce a great number of air bubbles of small dimensions to increase the efficiency of the skimmer in purifying water.

Furthermore, it must not require any manual adjustment in order to work in an optimum manner.

This aim is reached by a skimmer of the above-mentioned kind, namely a skimmer for aquariums comprising a first container able to contain water of an aquarium, water-air mixing means which create a mixed flow of water and air which enters inside said first container and rises upwards originating a foam, further comprising collecting means of said foam placed at the top of said container, characterized in that said mixing means are placed inside said first container and are also submersion means working when they are immersed in water, said first container is provided with an opening connected to said mixing through a water suction duct and it is also provided with an air supply means connected to said mixing means and having a free end communicating with the outside environment in order to take in air, so that said mixing means may mix water to be purified which arrives through said suction duct with air taken in from the outside environment through said air supply means, thus creating said mixed flow of water and air which rises upwards generating a foam which is collected inside said collecting means, said first container being further provided with at least one opening from which purified water goes out.

In this way it is easy to understand that the skimmer is much simpler since the number of ducts for water are notably reduced. Moreover, its dimension is highly reduced.

Thanks to the use of specialized water and air mixers, the produced air bubbles are smaller and, therefore more in number, and this increases the efficiency of the skimmer.

Furthermore, since at the entry only water is sucked because the mixing of water and air occurs inside the impeller, the efficiency of the mixing means is higher with a subsequent saving in space and necessary power.

These and other advantages of the present invention will be more evident from the following detailed description of some embodiments given only for illustrative but not limitative purposes with reference to the following drawings wherein:

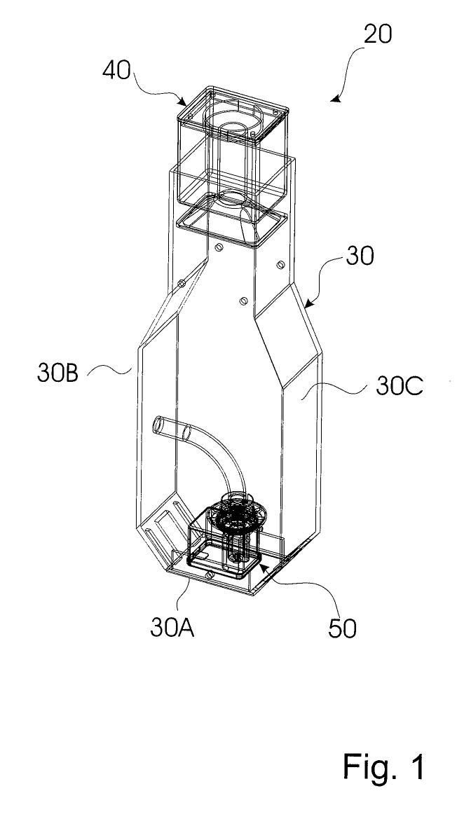

FIG. 1 is a perspective view of a skimmer according to the present invention;

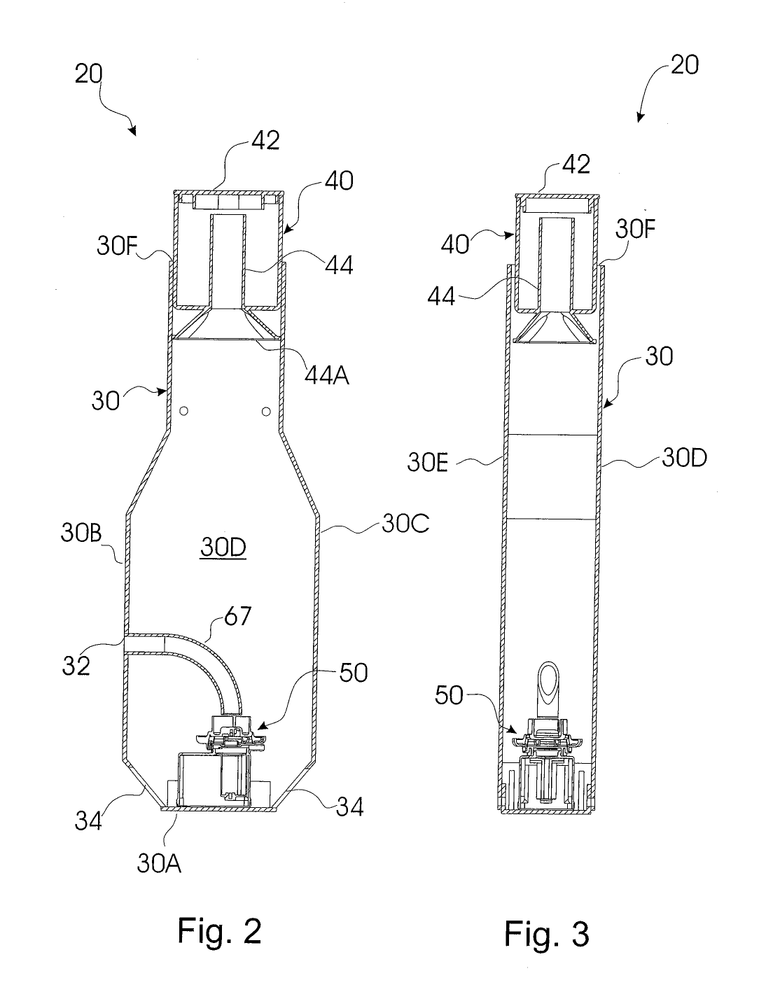

FIGS. 2 and 3 are two elevation cross-sections respectively a front and a side cross-section of the skimmer of FIG. 1;

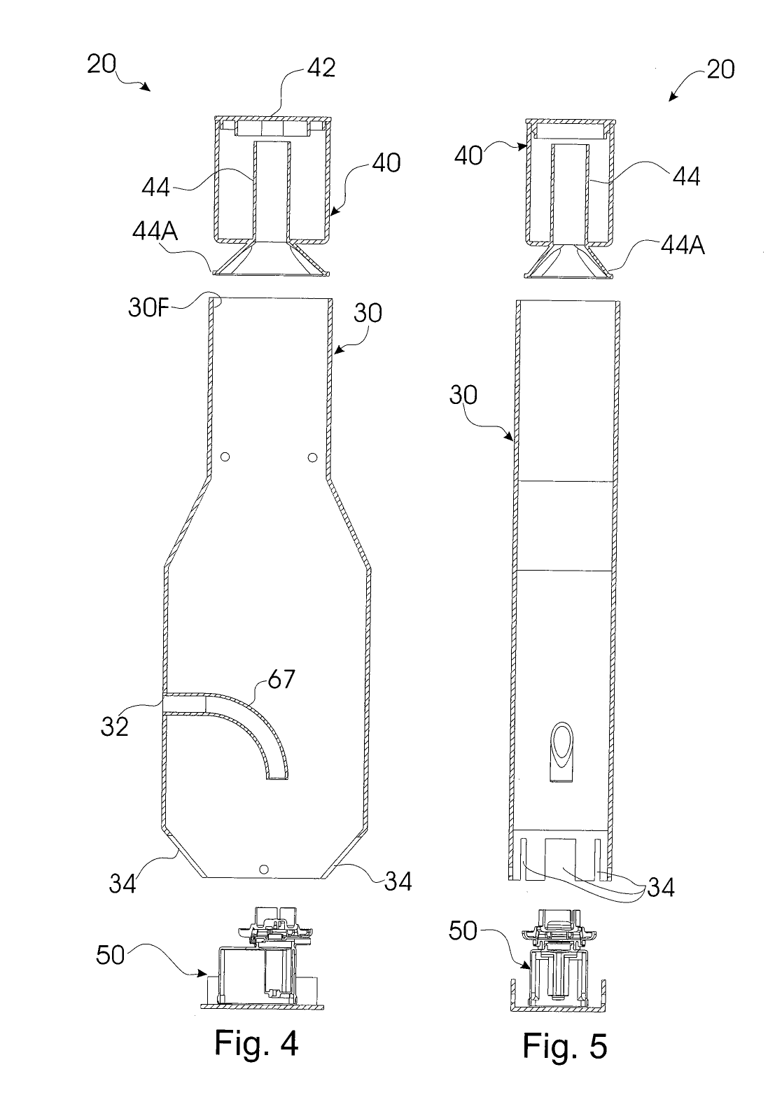

FIGS. 4 and 5 are two exploded cross-sections corresponding respectively to FIGS. 2 and 3;

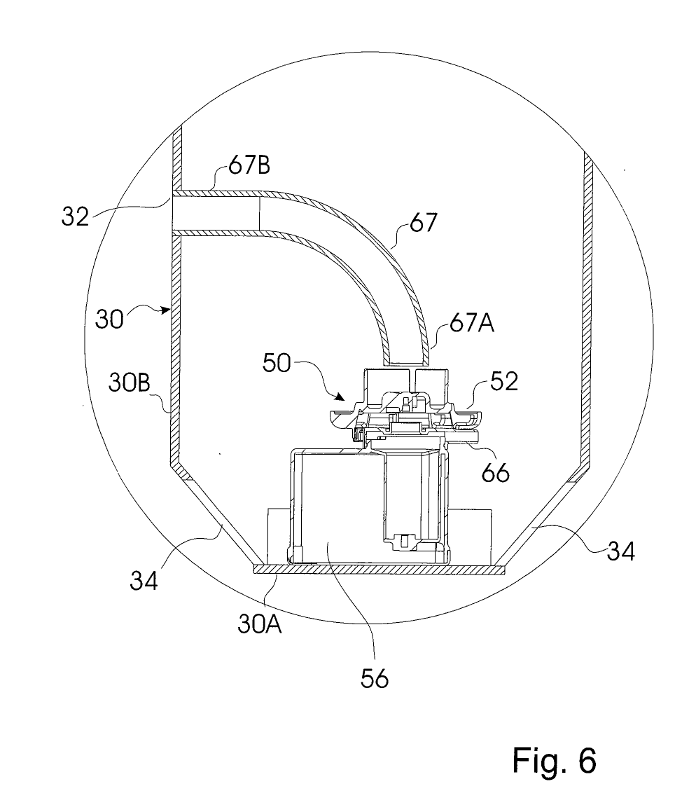

FIG. 6 is an enlarged view of FIG. 2;

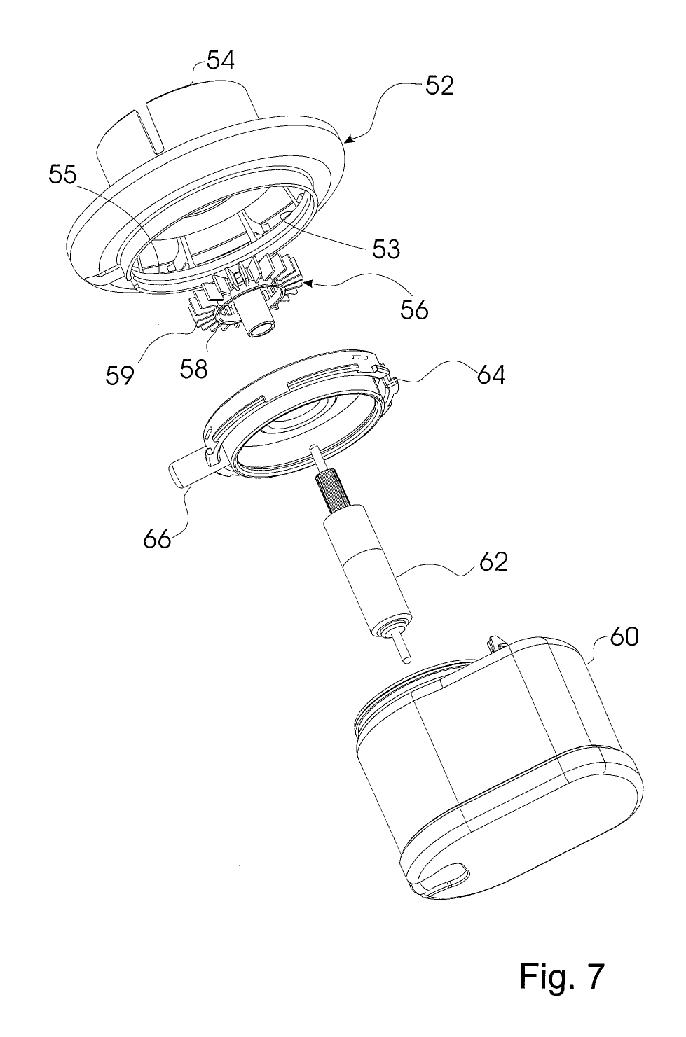

FIG. 7 is an exploded view of the aerator shown in the previous figures;

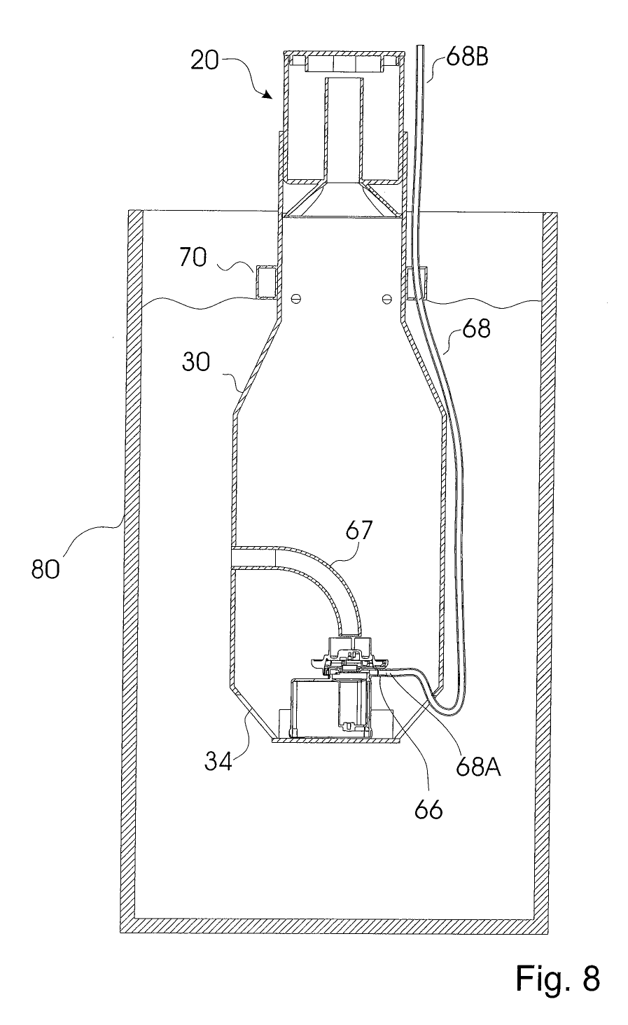

FIG. 8 is a front elevation view of a skimmer illustrated in FIGS. 1, 2, 3, 4, 5 inserted in an aquarium;

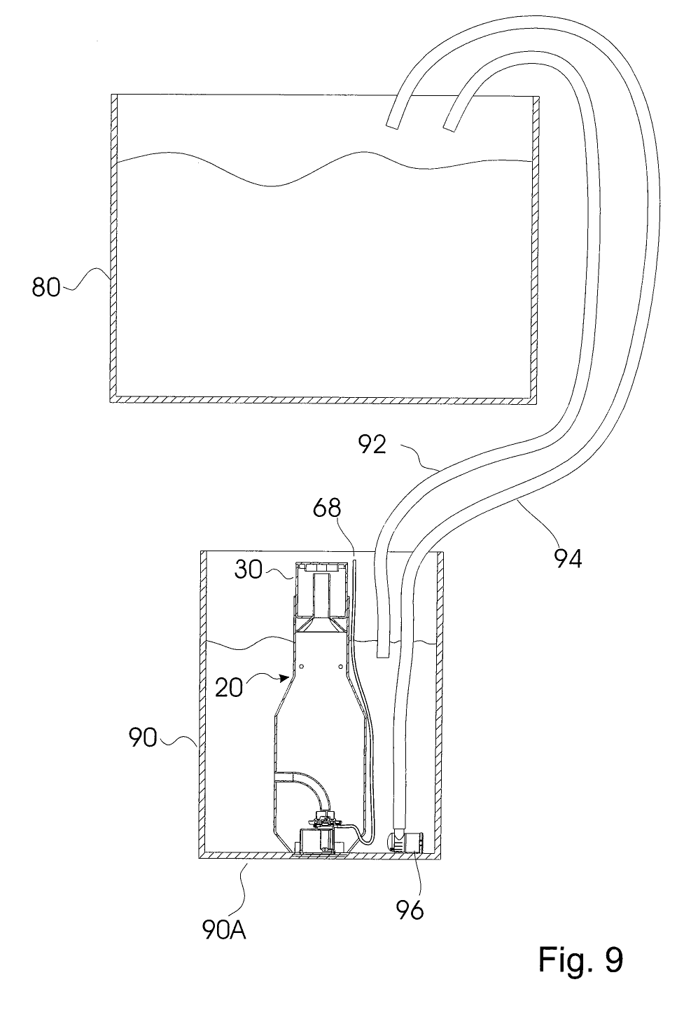

FIG. 9 is a front elevation view of a skimmer illustrated in FIGS. 1, 2, 3, 4, 5 inserted in a service tank or sump which is connected to an aquarium;

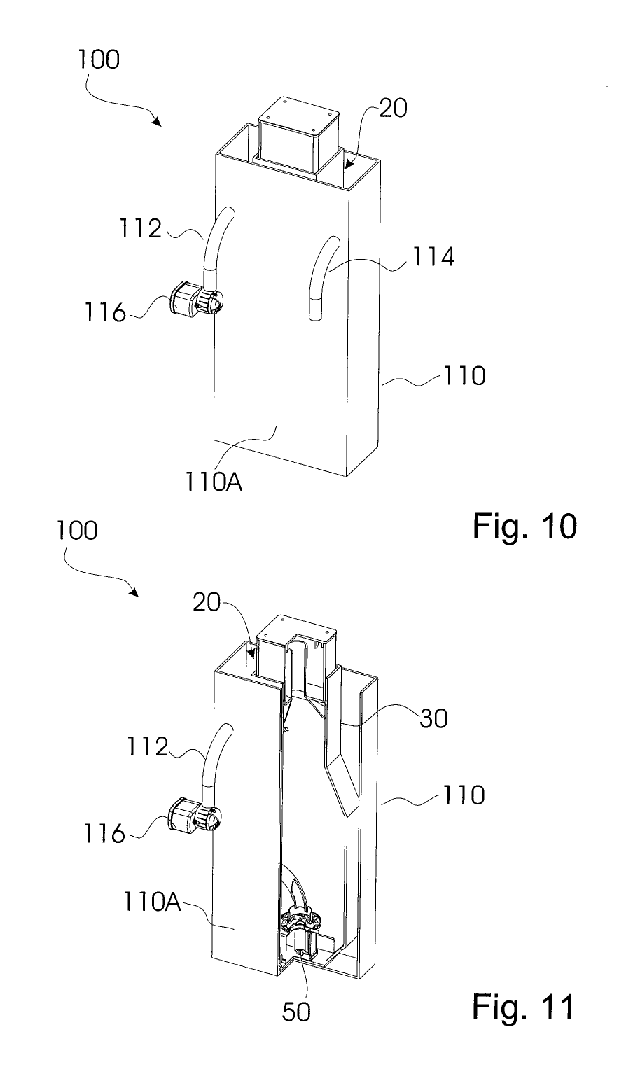

FIG. 10 is a perspective view of a skimmer according to a second embodiment of the invention skimmer;

FIG. 11 is a perspective view similar to FIG. 10, but partially sectioned;

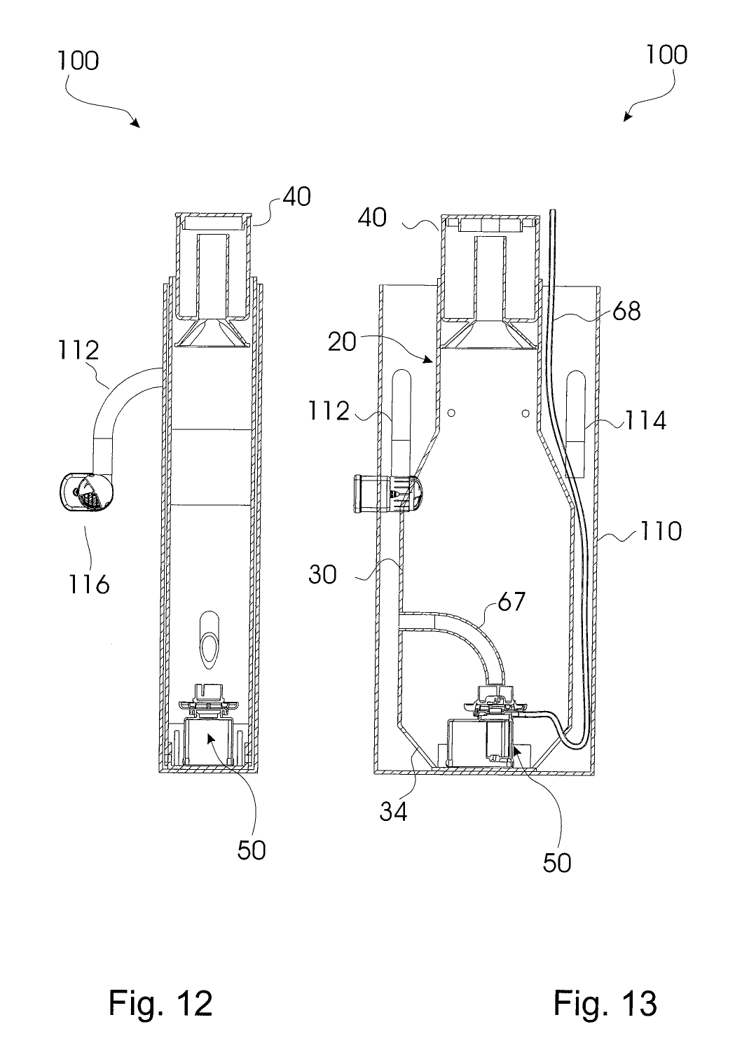

FIGS. 12 and 13 are two respectively elevation cross-sections, a front and a side cross-section of the skimmer of FIGS. 10 and 11;

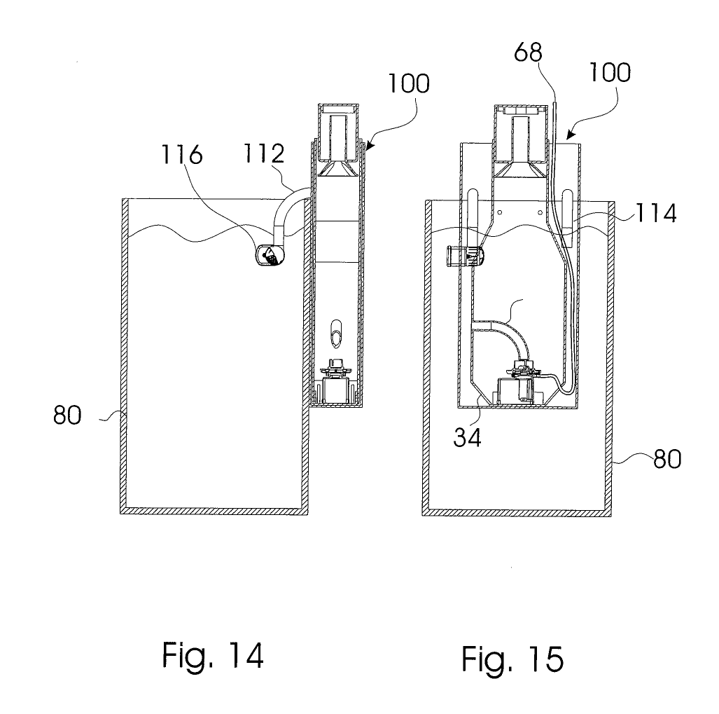

FIGS. 14 and 15 are respectively a transverse and front elevation cross-section of a skimmer according to FIGS. 10, 11, 12 and 13 mounted on the outside wall of an aquarium;

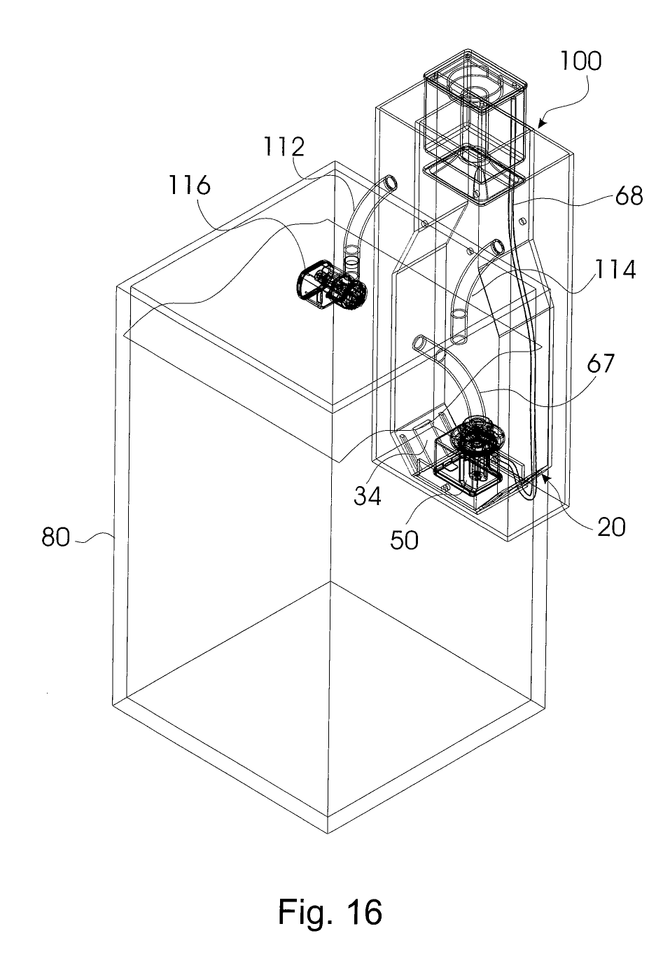

FIG. 16 is a perspective view of a skimmer according to FIGS. 14 and 15

In FIGS. 1, 2, 3, 4 and 5, a skimmer for aquariums both for sea or salt water, or fresh water is entirely indicated by reference 20.

The skimmer 20 comprises a container 30 with a substantially parallelepipedic shape having a bottom 30A, two opposite side walls 30B,30C, a front wall 30D, a rear wall 30E and a top open end 30F.

A glass 40 is mounted on the top open end 30F which is closed at the top by a cover 42 and a duct 44 passes through the bottom of the glass 40 which connects the inside of the container 30 with the inside of the glass 40.

The duct 44 arrives inside the container 30 forming a funnel 44A which allows collecting foam which forms in the container 30 more easily, as well described in the following.

The skimmer 20 also comprises a mixing device 50 of water and air positioned at the bottom 30A inside the container 30.

The mixing device of water and air is an aerator of the type described in the International patent application No. PCT/IT2004/000607 filed on 4 Nov. 2004 in the name of HYDOR srl and herewith incorporated by reference.

Shortly, the aerator 50, as better shown in FIGS. 6 and 7, comprises a conveying element with a substantially annular shape inside which an impeller chamber 53 is defined. The conveying element 52 is provided with a tang 54 from which water to be purified enters and, openings 55 are made on the surface defining the impeller chamber 53 from which water mixed with air comes out.

An impeller 56 is housed inside the impeller chamber 53 and it comprises a hollow hub 58 from which a plurality of vanes 59 comes out. Holes, not visible in figures, are made on the hub 58 between one vane and the other adjacent vane.

The impeller 56 is rotated by an electric motor 60 by means of a motor shaft 62 which connects the electric motor 60 and the impeller 56.

A channelling element 64 is mounted in a intermediate position between the impeller 56 and the electric motor 60 and it is provided with a small duct 66 for entry of air which is connected with the inside of the hub 58. As better described and illustrated in FIG. 8, an air intake duct 68 is connected to the small duct 66 whose free end is connected to the environment. Thanks to the channelling element 64, air comes through the small duct 66 and arrives inside the hub 58 and comes out from the holes of the hub 58 and then enters into the impeller chamber 53.

The tang 54 of the conveying element 52 is connected to a suction duct 67 for sucking water to be purified which has two ends: a first end 67A connected to the conveying element 52 and a second end 67B connected to an opening 32 made on the side wall 30B of the container 30.

During the functioning the electric motor 60 rotates the impeller 56 so that water enters inside the impeller chamber 53 through the tang 54 and then through the suction duct 67, and it creates a lower pressure which allows for sucking air from the outside through the small duct 66 for the entry of air.

Air sucked through the holes of the hub 58 comes inside the impeller chamber 53 and it is mixed with water generating a mixed flow of water and air which comes out from the openings 55 of the conveying element 52.

Then, the mixed flow of water and air contains many air bubbles which rises upwards inside the cylindrical container 30 filled with water, thus creating a foam which drags the harmful substances contained in the water.

The foam becomes thicker and thicker as it rises upwards and, consequently, it collects and transports more and more harmful substances. The foam which goes up along the cylindrical container 30, richer in harmful substances, passes through the duct 44 of the glass 40, overflows and collects on the bottom of the glass 40 which periodically has to be emptied.

In this way water which comes into the cylindrical container 30 is continuously purified.

As noted in FIGS. 2, 4, 6 and in particular in FIG. 5, slots 34 are made on the side wall 30B of the cylindrical container 30 near the bottom 30A which allow purified water to come out of the container 30.

In FIG. 8 a first application of the skimmer 20 is represented wherein the skimmer, as described above, is inserted in an aquarium 80.

The skimmer 20 is provided with a float 70 positioned on the outer surface of the cylindrical container 30, so it can float and the position in height of the skimmer with respect to the water level in the aquarium is always the same.

In fact, for correct functioning it is necessary that the skimmer 20 remains immersed in water so that the water level outside remains the same.

FIG. 8 shows that the air intake duct 68 placed near the side wall 30C has a first lower end 68A connected to the small duct 66 for entry of air in the aerator 50, and a second upper end 68B connected to the environment.

For the functioning of the skimmer 20, it is sufficient to feed the electric motor 60 of the aerator 50. In this manner water is taken from the aquarium 80 through the duct 67 and air is taken from the environment through the air intake duct 68 and they are mixed by the aerator 50, thus creating a foam full of harmful substances.

The purified water comes out from the slots 34 and then re-enters into the aquarium 80.

A second application of the skimmer 20 is illustrated in FIG. 9 wherein the skimmer is inserted in a service tank or “sump” 90 and laid down on its bottom 90A.

The service tank 90 is connected to the aquarium 80 by means of two ducts: a first duct 92 which carries water to be purified from the aquarium 80 to the service tank 90 and a second duct 94 which, thanks to a pump 96, purified water is returned by the skimmer 20, namely from the service tank 90 to the aquarium 80.

Since the level of water contained in the service tank is controlled and maintained constant, the skimmer 20 may be laid down on the bottom 90A of the service tank 90 thus assuring that the level of water outside the skimmer is always the same.

Obviously the functioning of the skimmer 20 occurs as already described with reference to FIG. 8.

In FIGS. 10, 11, 12 and 13 a second embodiment concerning a skimmer 100 is shown.

The skimmer 100 substantially comprises a second container 110 with a parallelepipedic shape inside which the previously described skimmer 20 is inserted and then it comprises the first container 30, the glass 40 and the aerator 50.

A first elbow tube 112 for entry of water and a second elbow tube 114 for the exit of water are mounted on the front wall 110A of the second container 110. A pump 116 is mounted on the free end of the first elbow tube 112 with the task to suck water to be purified from an aquarium and then to send it inside the second container 110, whereas the second elbow tube 114 has the task to take water purified by the second container 110 and to introduce it into the aquarium.

FIGS. 14, 15 and 16 represent an application of the skimmer 100.

The skimmer 100 is fixed on the outside wall of an aquarium 80 thanks to the two elbow tubes 112, 114 which are hooked on the upper edge of a wall of the aquarium 80.

For the functioning of the skimmer 100 it is sufficient to electrically feed the pump 116 and the aerator 50. In this way, due to the pump 116, water to be purified reaches the second container 110 through the first elbow tube 112, whereas water to be purified by the skimmer 100 re-enters into the aquarium through to the second elbow tube 114.

Water to be purified inside the second container 110 is then taken from the aerator 50 by means of the water suction duct 67 and mixed with air which arrives to the aerator 50 through the air intake duct 68. In this way, a foam containing harmful substances is inserted and then eliminated, whereas the purified water comes out from the slots 34 and re-enters into the second container 110.

It is easy to understand that the skimmer of the present invention is compact and simple in construction, above all when it is used inside an aquarium or when it is inserted in a service tank. Due to the use of the aerator 50, the ducts outside the skimmer have almost disappeared, not only in the two above cases, but also when the device is mounted outside an aquarium since, in order for water to enter into the second container 110 and take it out, the two elbow tubes, that hook the skimmer onto the upper edge of an aquarium wall, are used.

Furthermore, thanks to the aerator 50, much more air bubbles of smaller dimensions are generated with respect to what occurs in the skimmers of the prior art, so that a much thicker foam is created, and the harmful substances are more easily entrapped and transported upwards in order to be collected inside the glass placed at the top of the skimmer.

It should be noted that from each hole made in the hub 58 of the impeller 56 air comes out generating air bubbles and that the number of holes in the hub is very high. In fact, the impeller 56 has preferably a high number of vanes, for example from 24 to 36 and, considering that there is a hole between one vane and the adjacent vane, the number of holes in the hub is equal to the number of vanes and thus it is very high. Each hole works like a Venturi tube and, all together, they are able to generate a very strong flow of air which mixes with water sucked from the impeller generating a water flow containing a very high number of air bubbles which makes the skimmer extremely effective and efficient.

Moreover, the aerator requires much less supply power than the power required by currently commercialized pumps whose power is notably higher in order to compensate for the fact that, by sucking at the entry not only water but a mixture of water and air, they have a very low efficiency.

Finally, as soon as the skimmer is fed, it works at full capacity in a short time, that is in a few dozen seconds, and in the container 30 a foam is formed which overflows from the duct 44 and it is collected into the glass 40. Therefore, the skimmer begins at once to purify the water, in contrast to what happens in the standard skimmers wherein it is necessary to wait many minutes before they begin to purify the water.

Moreover, the skimmer of the present invention, different from the standard skimmers, does not require any adjustment in height of the duct from which the purified water comes out.

The efficiency of this skimmer is such that it can also be used in aquariums containing fresh water obtaining an optimum purification of water, as well.

Finally, it is evident that any conceptual or functional modifications or changes of the invention fall inside the scope of the present invention.

1. Skimmer for aquariums comprising a first container able to contain water of an aquarium, water-air mixing means which create a mixed flow of water and air which enters inside said first container and rises upwards originating a foam, further comprising collecting means of said foam placed at the top of said container, characterized in that said mixing means are placed inside said first container and are also submersion means working when they are immersed in water, said first container is provided with an opening connected to said mixing means through a water suction duct and it is also provided with air supply means connected to said mixing means and having a free end communicating with the outside environment in order to take in air, so that said mixing means may mix water to be purified which arrives through said suction duct with air taken in from the outside environment through said air supply means, thus creating said mixed flow of water and air which rises upwards generating a foam which is collected inside said collecting means, said first container being further provided with at least one opening from which purified water goes out.

2. Skimmer according to claim 1, characterized in that said submersion mixing means comprise an impeller housed inside an impeller chamber, and said air supply means are connected to said impeller chamber.

3. Skimmer according to claim 1, characterized in that said impeller comprises a hub and said air supply means are connected to the inside of said hub, said hub being provided with holes so that said air taken in from the outside environment arrives inside said hub and, coming out from said holes, is mixed with water inside said impeller chamber (53) thus creating said mixed flow of water and air.

4. Skimmer according to claim 1, characterized in that said first container comprises floating means able to make said first container float when it is placed inside an aquarium, so as to maintain the position of said first container unchanged with respect to the water level outside said first container.

5. Skimmer according to claim 1, characterized in that said first container is provided with a bottom able to be laid down on the inner bottom of a service tank or sump which is connected to said aquarium.

6. Skimmer according to claim 1, characterized in that it comprises a second container inside which said first container is placed, said second container is provided with a first inlet duct to receive water to be purified directly from said aquarium and a second outlet duct to introduce purified water into the aquarium, said second container supplies said first container with purified water through said suction duct of said first container and receives water to be purified through said at least one opening of said first container.

7. Skimmer according to claim 6, characterized in that it comprises a pump which takes water from said aquarium and introduces it into said second container through said first inlet duct.

8. Skimmer according to claim 6, characterized in that said second container comprises hooking means in order to be fixed to an outside wall of said aquarium.

9. Skimmer according to claim 8, characterized in that said hooking means comprise of said first inlet duct and said second outlet duct which have an elbow shape able to be hooked onto the upper edge of said wall of an aquarium.

10. Aquarium characterized in that it comprises a skimmer according to claim 1.

11. Aquarium according to claim 10 which comprises a skimmer according to claim 5, characterized in that said aquarium and said sump are connected to each other by means of a first duct which takes in water to be purified from said aquarium to said sump and a second duct which takes in purified water from said sump to said aquarium by means of said pump inserted in said second duct
